(19) United States
(12) Patent Application Publication
(10) Pub. No.: US 2023/0377469 A1
(43) Pub. Date: Nov. 23, 2023

(54) METHOD AND SYSTEM FOR FLIGHT PATH CONTROL OF AN AIRCRAFT

(71) Applicant: Volocopter GmbH, Bruchsal (DE)

(72) Inventors: Markus ORTLIEB, Karlsruhe (DE); Sonja HAUBER, Sachsenheim (DE)

(73) Assignee: Volocopter GmbH, Bruchsal (DE)

(21) Appl. No.: 18/138,181

(22) Filed: Apr. 24, 2023

(30) Foreign Application Priority Data
Apr. 28, 2022 (DE) 102022110343.9

(51) Int. Cl. G08G 5/00

(52) U.S. Cl. CPC G08G 5/006; G08G 5/0069; G08G 5/0021

(57) ABSTRACT

A method for flight path control of an aircraft in which boundaries of an airspace authorized for a mission of the aircraft are defined, which boundaries
a) include a hard boundary, which delimits an area forbidden to the aircraft, and
b1) a warning boundary, at which safety measures are initiated when reached by the aircraft, and/or
b2) a soft boundary, at which emergency measures are initiated. To calculate a location of the warning and/or soft boundary, parameters of an actual flight status of the aircraft, such as speed, altitude, path angle or other factors, for example wind and/or weather conditions, are continuously determined and dynamically taken into consideration by a computer-assisted flight path controller of the aircraft and/or by an external controller. The aircraft-located and/or external controller subsequently checks whether the aircraft presently or in future infringes the mentioned boundaries at its current position.

### CROSS-REFERENCE TO RELATED APPLICATIONS

This application claims priority to German Patent Application No. 10 2022 110 343.9, filed Apr. 28, 2022, which is incorporated herein by reference as if fully set forth.

### TECHNICAL FIELD

The invention relates to a method for flight path control of an aircraft, in particular in an unmanned aircraft, in which boundaries of an airspace authorized for a mission of the aircraft are defined, which boundaries a) comprise at least one hard boundary, which delimits an area forbidden to the aircraft, and in addition b1) a warning boundary, at which safety measures are initiated when it is reached by the aircraft, and/or b2) a soft boundary, at which emergency measures are initiated when it is reached by the aircraft.

The invention furthermore relates to a flight path control system of an aircraft, in particular an unmanned aircraft, which flight path control system is designed to define boundaries of an airspace authorized for a mission of the aircraft, which boundaries a) comprise at least one hard boundary, which delimits an area forbidden to the aircraft, and in addition b1) a warning boundary, at which safety measures are initiated when it is reached by the aircraft, and/or b2) a soft boundary, at which emergency measures are initiated when it is reached by the aircraft.

### BACKGROUND

Especially for the operation of UAVs (“unmanned aerial vehicles”—unmanned aircraft), in Europe boundaries of the airspace authorized for a mission, i.e., for a flight, are defined on the basis of quantitative calculation methods. These previously known methods use statistical volumes which are calculated on the basis of conservative assumptions. The overall mission scope has to remain within a so-called risk buffer and cannot infringe so-called adjacent areas. Defined boundaries result therefrom, at which boundaries contingency methods (or safety measures) or emergency procedures (or emergency measures) have to be respectively triggered at the latest, which regularly takes place in an automated manner (cf. the illustration in FIG. 1). The boundary at which a “contingency procedure”, i.e., a safety measure, is started is called a “warning boundary” hereinafter. A so-called “soft boundary” describes the boundary at which “emergency procedures” or emergency measures are initiated. That (preferably horizontal) boundary which protects the above-mentioned “adjacent areas” is designated as a “hard boundary”.

A distinction is not made hereinafter within the present description between UAVs and other aircraft, because the invention is fundamentally applicable to all types of aircraft. However, it is particularly intended for use in unmanned aircraft, because such aircraft naturally do not have a pilot who could have a corrective effect on the flight path of the aircraft in the event of danger.

The described functionality is used to define a so-called “geocage”, thus a defined volume or corresponding airspace, which volume the UAV cannot leave (cf. FIG. 1), or a so-called “geofence”, wherein, vice versa, this is a volume into which the aircraft cannot penetrate. The horizontal and vertical boundaries of the mentioned volumes are considered separately hereinafter to simplify the description in individual cases. The focus here is on the horizontal boundaries. However, a combined consideration is generally also possible or such consideration may also readily be transferred in each case to the vertical boundaries.

The use of the above-described, previously known geocaging and geofencing methods with static flight area boundaries has the result that in many assumed flight statuses, the so-called “flight geography”, thus the volume actually available for the mission, is smaller than would actually be required for the relevant flight status. The mission scope is thus unnecessarily restricted in a disadvantageous manner, and remedial measures have to be initiated before they are required by flight physics. As a consequence areas having narrow passages, for example, possibly cannot be flown at all or can only be flown very slowly—in particular if the aircraft/UAVs involved have sluggish performance characteristics.

### SUMMARY

The invention is based on the object of refining a method and a system of the above-mentioned type in each case so that no unnecessary restriction of the mission scope takes place, due to which difficult areas also become accessible to aircraft, in particular also at elevated flight speed.

This object is achieved according to the invention by a method having one or more of the features described herein and by a system having one or more of the features described herein.

Advantageous refinements of the concept according to the invention are defined below and in the claims.

One preferred use of the method according to the invention or the flight path control system according to the invention relates to an aircraft, in particular an unmanned aircraft (UAV), which is controlled by means of a method according to the invention and/or which is equipped with a flight path control system according to the invention.

A method according to the invention for flight path control of an aircraft, in particular an unmanned aircraft, in which boundaries of an airspace authorized for a mission of the aircraft are defined, which boundaries a) comprise at least one hard boundary, which delimits an area forbidden to the aircraft, and in addition b1) a warning boundary, at which safety measures are initiated when it is reached by the aircraft, and/or b2) a soft boundary, at which emergency measures are initiated when it is reached by the aircraft, is characterized in that to calculate a location of the warning boundary and/or the soft boundary, preferably starting from the hard boundary, parameters of an actual flight status of the aircraft, such as a current speed, a current altitude, a current path angle, or other current factors, in particular environmental factors, for example wind and/or weather conditions, are continuously determined and dynamically taken into consideration by a computer-assisted flight path controller of the aircraft and/or by an external, computer-assisted flight path controller; and that the computer-assisted flight path controller of the aircraft and/or the external, computer-assisted flight path controller subsequently checks whether the aircraft presently or in future infringes at least one of the mentioned boundaries at its current position with the mentioned parameters. Corresponding countermeasures can then be taken—preferably automatically. In particular, a flight path of the aircraft can be changed.

In this way, the invention enables dynamic flight area scaling. Further influencing parameters, which can be incorporated in the calculation of the dynamic flight area scaling, are, for example, environmental factors, such as the above-mentioned wind, the availability of navigation satellites, a navigation performance (i.e., the accuracy of the navigation) in general, or maximum height differences of an overflown terrain.

Due to the proposed dynamic flight area scaling, according to the invention, there is no unnecessary restriction of the mission scope, so that difficult areas also become accessible to aircraft, in particular also at elevated flight speed.

A flight path control system according to the invention, which is suitable for carrying out the method according to the invention, of an aircraft, in particular in an unmanned aircraft, which flight path control system is designed to determine boundaries of an airspace authorized for a mission of the aircraft, which boundaries a) comprise at least one hard boundary, which delimits an area forbidden to the aircraft, and in addition b1) a warning boundary, at which safety measures are initiated when it is reached by the aircraft, and/or b2) a soft boundary, at which emergency measures are initiated when it is reached by the aircraft, is characterized in that the flight path control system is designed, for calculating a location of the warning boundary and/or the soft boundary, preferably starting from the hard boundary, to continuously determine and dynamically take into consideration parameters of an actual flight status of the aircraft, such as a current speed, a current altitude, a current path angle, or other current factors, in particular environmental factors, for example wind and/or weather conditions, in particular by way of a computer-assisted flight path controller of the aircraft and/or by way of an external, computer-assisted flight path controller; wherein the flight path control system is furthermore designed to check, in particular by way of the computer-assisted flight path controller of the aircraft and/or by way of the external, computer-assisted flight path controller, whether the aircraft presently or in future infringes at least one of the mentioned boundaries at its current position with the mentioned parameters and if needed to initiate corresponding control measures for the aircraft.

According to the invention, conservative assumptions are accordingly no longer made for the calculation of the soft boundary and the warning boundary but rather parameters of the actual flight status are taken into consideration, such as the current speed, the altitude, and/or the path angle of the aircraft or other factors (for example weather conditions). This has the result that dynamically variable volumes result from the previous static volumes, the boundaries of which represent the physical behavior of the aircraft and its environment at the respective point in time of the validity. A slowly flying UAV can therefore fly closer to a boundary than was possible with the previous methods, since “contingency procedures” (thus safety measures of the type “Hover as soon as possible”—go into hovering flight as soon as possible, as a possible rescue maneuver) at lower speeds require less space for their performance. The “emergency procedures”, thus emergency measures, such as a flight termination system, which deliberately causes the UAV to crash within the risk buffer zone, can also bring the UAV to the ground within a shorter distance in this manner.

A distinction is not made in principle in the scope of the present description between the above-mentioned geocaging and geofencing methods, because it does not play a role according to the invention from which side an aircraft approaches a (flight area) boundary which is defined or is to be defined.

One advantageous refinement of the method according to the invention provides that a distance between the hard boundary and the soft boundary and/or between the soft boundary and the warning boundary at a location within the airspace is dynamically dependent on a current speed of the aircraft. In this way, the location of the boundaries is dependent on the current speed of the aircraft and no longer has to be conservatively estimated (in particular not in relation to a highest possible speed of the aircraft).

Another advantageous refinement of the method according to the invention moreover provides that the distance becomes greater with increasing current speed of the aircraft and vice versa. In this way, it is taken into consideration that an aircraft flying faster will also cover a greater distance before a countermeasure can be taken or shows its effectiveness.

In a further embodiment of the invention, the flight direction of the UAV can additionally also be taken into consideration. Volumes are thus no longer scaled in an undirected manner. This is because it has been shown that an undirected scaling of the boundaries results in additional conservative limiting of the flight area, which has no relevance with respect to flight physics and unduly restricts the available airspace. Such boundaries, which are in the flight direction, can be classified as more critical in the scope of this embodiment than boundaries which, for example, are parallel to or counter to the flight direction. In this way, a UAV flying parallel to the warning boundary can be closer thereto than a UAV flying frontally toward the boundary.

Accordingly, it can be provided in a refinement of the method according to the invention that a distance between the hard boundary and the soft boundary and/or between the soft boundary and the warning boundary at a location within the airspace is dynamically dependent on a current flight direction of the aircraft relative to the mentioned boundaries.

In a special different refinement of the method according to the invention, it can additionally also be provided that boundaries which are in the flight direction are set at a greater distance from a current location of the aircraft than boundaries which are parallel to or counter to the flight direction.

In this way, volumes may be computed which are adapted optimally to a current mission or to a given flight status of a relevant aircraft.

One particularly advantageous refinement of the method according to the invention provides that the boundaries are defined in that: i) initially a course of the hard boundary is defined; ii) then depending on the flight status and preferably additionally depending on environmental factors, distances d_{cont} and dᵣᵢₛₖ are calculated; iii) then a course of the soft boundary and the warning boundary are defined in that a course of the hard boundary is reproduced at a distance dᵣᵢₛₖ to define the soft boundary and a course of the soft boundary is reproduced at a distance d_{cont} to define the warning boundary. Alternatively, to define the warning boundary, the hard boundary can be reproduced at the distance d_{cont}+dᵣᵢₛₖ. Such a method can also be designated as polygon scaling. In this case, the aircraft is preferably located inside, i.e., within a polygon representing the relevant boundary.

Very generally, the calculation or the determination of a location of the warning boundary and the soft boundary is preferably made dependent on an actual flight status of the aircraft and possibly further influencing factors. At each point in time t, for this purpose the mentioned boundaries (soft boundary and warning boundary) are derived by means of analytical models from the (generally permanently specified) hard boundary. The mentioned analytical models preferably take into consideration, among other things, the current speed, worst-case behavior of the aircraft in the event of control loss, the expected crash trajectory in the event of a flight termination, and/or ability to carry out a recovery maneuver at the respective point in time. It is subsequently checked whether the present position of the aircraft infringes these boundaries, and corresponding countermeasures are initiated if needed.

In the scope of the above-described simplest embodiment of the method according to the invention, infringements of the flight area boundaries in directions which are not relevant from a physical viewpoint or are only relevant with very low probability can also be taken into consideration. An extremely advantageous other refinement of the method according to the invention therefore provides that a probability of infringement of a boundary at a certain point by the aircraft is calculated in that an angle difference between the relevant boundary and a current flight direction of the aircraft is taken into consideration, wherein the probability decreases with increasing angle difference from the current flight direction, which probability is used for the dynamic calculation of a location of the warning boundary and/or the soft boundary.

In this way, the flight area boundaries may be adapted even better to the current conditions, due to which the available airspace can be used more efficiently.

In a refinement of this concept, it can additionally also be provided in a method according to the invention that to calculate the boundaries, a Euclidean distance to a linear boundary section is described as a piecemeal continuous function of a direction angle between the current flight direction and a respective point on the boundary section, wherein the resulting distance functions are scaled using a weighting function, which weighting function depicts the probability of an abrupt direction change of the aircraft as a function of the direction angle, from which new distance values result, which take into consideration both the Euclidean distance and also the probability that the boundary will be infringed at the respective point.

In this way, the location of the boundaries may be adapted optimally to the present flight status of the aircraft.

For the purpose of a particularly simple and efficient implementation of the method according to the invention, it can additionally also be provided in a corresponding refinement that the new distance values are searched for a minimum and then this minimum is compared to the distances d_{cont} and dᵣᵢₛₖ.

A particularly simple embodiment results if a Gaussian bell curve is preferably used as a weighting function. However, the invention is in no way restricted to the use of such a weighting function. For example, in another refinement of the method according to the invention, it can be provided that the weighting function is derived on the basis of empirical data, which data in particular depict physical capabilities of the aircraft for the direction change in the extreme case.

In this way, an even better adaptation to the actual conditions may be achieved.

It has proven to be particularly advantageous if, in the course of still another refinement of the method according to the invention, the distance, weighted on the basis of the flight direction, to the boundaries is used as the foundation for a decision about the initiation of control measures for the aircraft. In this way, an intervention is only made in the carrying out of the flight if this is absolutely required due to the present location.

The above-described flight path control system is preferably furthermore designed to carry out an embodiment of the method according to the invention.

To achieve similar direction-dependent results, the above-mentioned surface scaling (polygon scaling) with respect to the distances of the aircraft to the boundaries can also be weighted. This approach is possibly inferior with regard to the computing effort of the above-described methods, but nonetheless is covered by the scope of the described invention.

Alternatively, geocages can also be derived on the basis of a previously defined flight path and a direction resulting therefrom and implemented similarly to a “tunnel in the sky”.

### BRIEF DESCRIPTION OF THE DRAWINGS

Further properties and advantages of the invention result from the following description of exemplary embodiments on the basis of the drawings.

FIG. 1 shows an aircraft with associated mission airspace for the purpose of explaining the concepts introduced above;

FIG. 2 shows an embodiment of the method according to the invention based on the method of polygon scaling;

FIG. 3 illustrates fundamental considerations for the direction-dependent weighting or determination of boundaries; and

FIG. 4 shows a possible weighting of the distance function with an exemplary weighting function.

### DETAILED DESCRIPTION

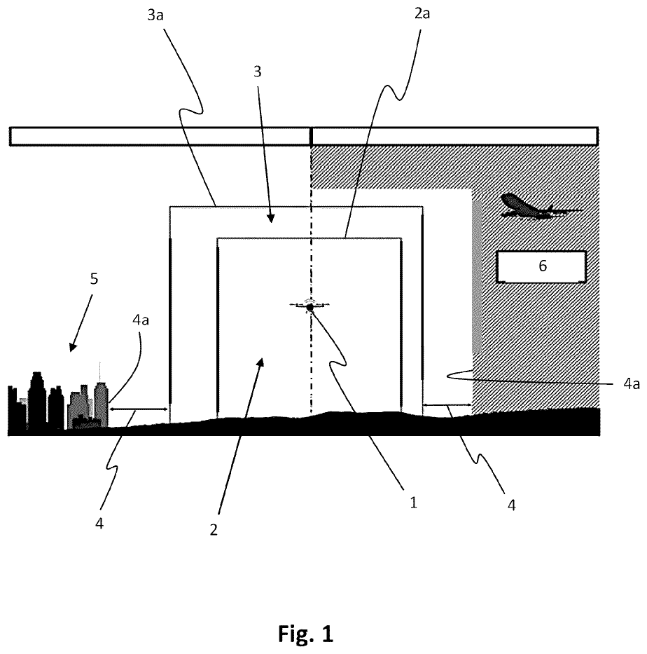

In FIG. 1, a preferably unmanned aircraft (UAV) is shown within its mission airspace 2 at reference sign 1. The so-called safety volume (“contingency volume”) 3 is arranged around the mission airspace 2. The mission airspace 2 and the safety volume 3 together form the so-called operative airspace for the aircraft 1. Leaving the mission airspace 2 generally results in the initiation of so-called safety measures, while leaving the safety volume 3 results in the initiation of so-called emergency measures. Outside the safety volume 3, a risk buffer zone 4 is defined in each case in relation to an adjacent region 5 or an adjacent airspace 6. The so-called hard boundary 4a is located at the end of the risk buffer zone 4. The boundary of the mission airspace 2 is formed by the warning boundary 2a, and the boundary of the safety volume 3 is formed by the soft boundary 3a.

The aircraft 1 preferably comprises a computer-assisted flight path controller, preferably located on board, which forms a flight path control system according to the invention but is not shown in FIG. 1 for reasons of clarity. The aircraft 1 is preferably capable of determining its current flight status, in particular the flight direction, altitude, flight speed, and other parameters sensorially, i.e., by means of suitable sensors (not shown). The aircraft 1 is preferably also capable of determining certain environmental parameters, such as the wind direction or the like, sensorially, i.e., by means of suitable sensors (not shown). Additionally or alternatively, the mentioned parameters can be externally communicated to the aircraft 1, for example from a suitably equipped ground station (not shown). Furthermore, a ground-based flight path controller (also not shown) can additionally or alternatively be used for the UAV 1.

When the UAV 1 reaches one of the mentioned boundaries 2a-4a, matched, scaled measures (flight maneuvers) are automatically initiated and carried out in each case by the flight path controller.

As can also be seen from FIG. 1, a hard boundary 4a is also defined with respect to the adjacent airspace 6 in the vertical direction, i.e., upward, while only a horizontal hard boundary 4a generally has to be defined with respect to the adjacent region 5 or the structures there. However, the invention is in no way restricted to such conditions.

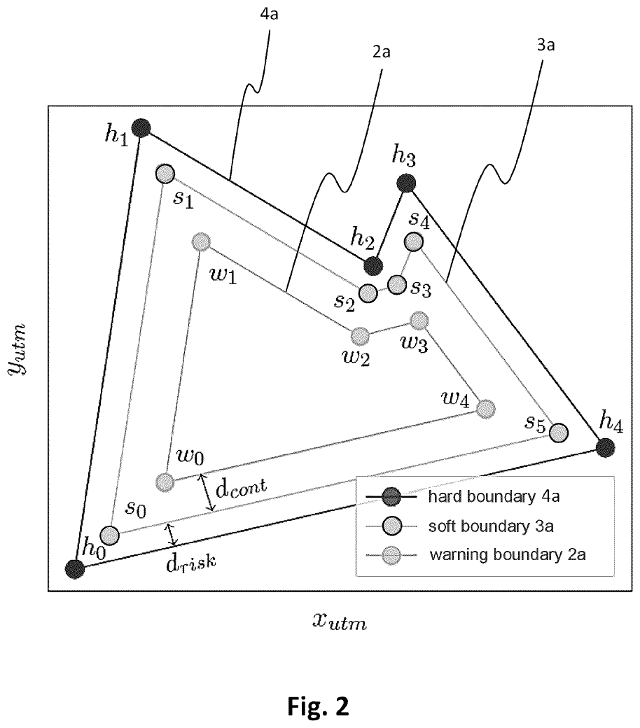

FIG. 2 shows a possible implementation of the method according to the invention in the form of a so-called polygon scaling. Horizontal boundaries are shown, wherein the two coordinate axes indicate corresponding horizontal distances xᵤₜₘ, yᵤₜₘ For this purpose, initially those points are known or specified which form the hard boundary 4a (symbolized in FIG. 2 by dark dots, which are designated by h₀ to h₄). Depending on a flight status of the aircraft (not shown) and optionally possible or known environmental factors, the distances d_{cont} and dᵣᵢₛₖ shown in FIG. 2 are calculated, preferably by the mentioned flight path controller(s), using which the “soft boundary” (3a) and the “warning boundary” (2a) are scaled. dᵣᵢₛₖ designates the distance of the soft boundary 3a (light, bordered points s₀ to s₅) from the hard boundary 4a, and d_{cont} designates the distance of the warning boundary 2a (light points w₀ to w₄) from the soft boundary 3a. An array of similar polygons results in this way. It is subsequently checked within which polygons the aircraft is located and corresponding flight statuses are set or flight control measures are initiated. This all takes place in or by a computer-assisted flight path controller of the aircraft and/or by an external, computer-assisted, preferably ground-based flight path controller (not shown), as already noted.

It is essential that the soft boundary 3a and the warning boundary 2a do not have to be defined before the flight, but rather they can be adapted during the mission continuously and as a function of the current conditions.

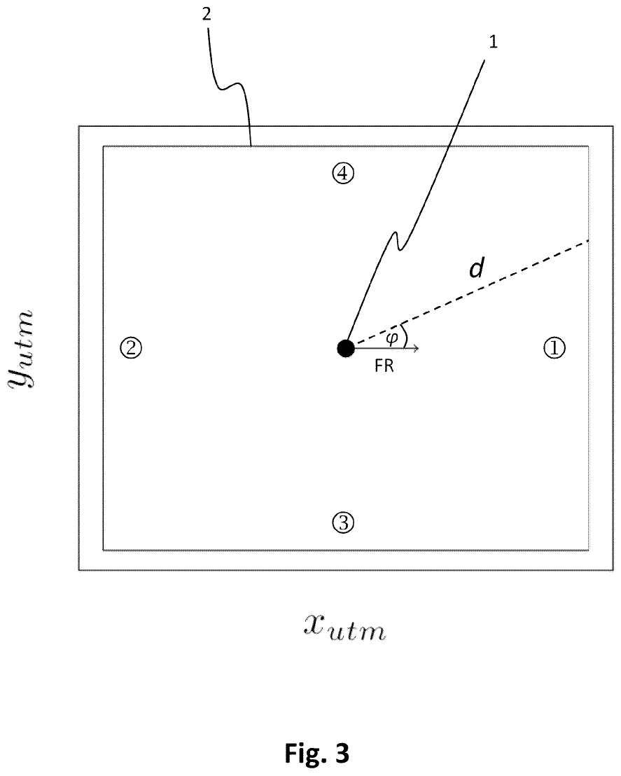

While in the course of the simplest embodiment of the method according to the invention, infringements of the flight area boundaries are also taken into consideration in those directions which are not relevant or are only relevant with very low probability from a physical aspect, an advantageous refinement of the method also takes into consideration the flight direction when defining the flight area boundaries. This approach is based on the assumption that the probability of infringing a flight area boundary at a certain point of the geocage decreases with increasing angle difference from the current flight direction. FIG. 3 shows, at reference sign 1, a UAV or another aircraft with simultaneous indication of the flight direction FR in a simple rectangular geocage or mission airspace 2, the boundaries of which are designated by \textcircled{1} to \textcircled{4}. Although the UAV 1 is positioned precisely centrally inside the geocage 2, the infringement of the boundary \textcircled{1} would be significantly more probable than an infringement of the boundary \textcircled{2} (or the boundaries \textcircled{3} and \textcircled{4}). This applies accordingly to all boundaries 2a-4a according to FIG. 1. This difference is taken into consideration in a corresponding refinement of the method according to the invention, as described in the introductory part of the description.

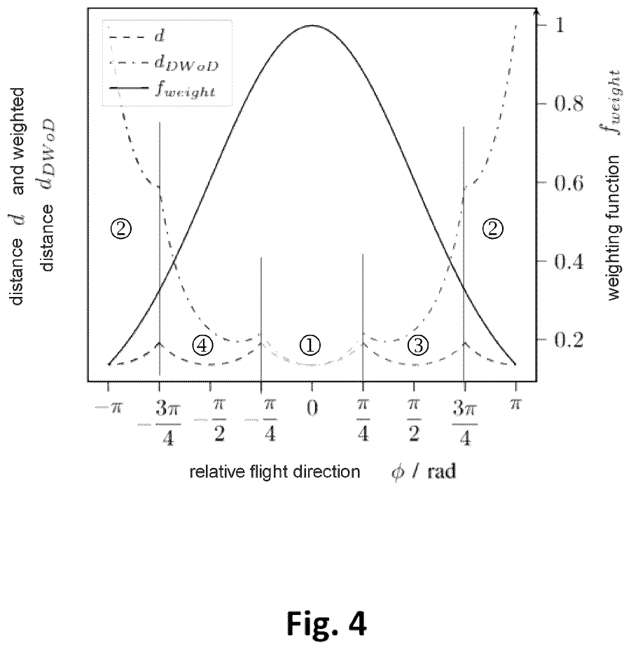

FIG. 4 shows a possible procedure for this purpose, in which the Euclidean distances d to each rectangle edge \textcircled{1} to \textcircled{4} (of the geocage 2 in FIG. 3) is described as a piecemeal continuous function of the (direction) angle φ between the flight direction (FR; FIG. 3) and a respective edge point (direction angle). The resulting distance functions d are scaled using a weighting function ƒ_{weight}, which depicts the probability of an abrupt direction change as a function of the direction angle φ. New distance values result therefrom, which take into consideration both the Euclidean distance and the probability that the geocage will be infringed at the respective edge point.

In FIG. 4, the relative flight directions are plotted on the abscissa as angles φ in relation to the rectangle edges \textcircled{1} to \textcircled{4} according to FIG. 3 in radians (dashed line d). The solid line represents the weighting function ƒ_{weight}, in the present case a simple Gaussian bell curve without restriction. The dot-dash line indicates the distance functions scaled using the weighting function, from which the above-mentioned new distance values d_{DW∘D} result.

To check whether the aircraft is too close to a boundary, in particular to the hard boundary, d_{cont} and dᵣᵢₛₖ also have to be determined for this method (cf. FIG. 2). A possible implementation can comprise searching the analytical description of the distance d or the weighted distance d_{DW∘D} for a minimum and comparing whether the required distances d_{cont} and dᵣᵢₛₖ (cf. FIG. 2) are observed.

The critical point under the assumptions made for observing the geocage does not necessarily have to correspond to the points of the geometric least distance. This is the case in particular if the point of the least distance is counter to the flight direction (cf. edge \textcircled{2} in FIG. 3).

The weighting function shown in FIG. 4 is by way of example a Gaussian bell curve, to which reference has already been made, while in a preferred implementation empirical data can be used to derive a suitable weighting function, which data depict or take into consideration the physical capabilities of the relevant aircraft for a direction change in the extreme case. The distance d_{DW∘D} to the flight area boundaries weighted on the basis of the flight direction FR is then preferably used as the foundation for the decision about initiating measures, which decision is preferably made automatically by the above-mentioned computer-assisted flight path controller onboard the aircraft and/or by the external (ground-based), computer-assisted flight path controller.

1. A method for flight path control of an aircraft (1), in which boundaries of an airspace authorized for a mission of the aircraft (1) are defined, said boundaries
a) comprise at least one hard boundary (4a), which delimits an area forbidden to the aircraft (1), and at least one of
b1) a warning boundary (2a), at which safety measures are initiated when the warning boundary is reached by the aircraft (1), or
b2) a soft boundary (3a), at which emergency measures are initiated when the soft boundary is reached by the aircraft (1),
the method comprising:
calculating a location of at least one of the warning boundary (2a) or the soft boundary (3a) by dynamically taking into consideration parameters of an actual flight status of the aircraft (1), including at least one of a current speed, a current altitude, a current path angle (φ), or environmental factors that are continuously determined using at least one of a computer-assisted flight path controller of the aircraft (1) or an external, computer-assisted flight path controller; and
subsequently checking whether the aircraft (1) presently or in future infringes at least one of the warning, soft, or hard boundaries (2a-4a) at a current position having the mentioned parameters using the at least one of the computer-assisted flight path controller of the aircraft (1) or the external, computer-assisted flight path controller.

2. The method as claimed in claim 1, wherein at least one of a distance (dᵣᵢₛₖ) between the hard boundary (4a) and the soft boundary (3a) or a distance (d_{cont}) between the soft boundary (3a) and the warning boundary (2a) at a location within the airspace is dynamically dependent on the current speed of the aircraft (1).

3. The method as claimed in claim 2, wherein the distance (d_{cont}, dᵣᵢₛₖ) becomes greater with increasing the current speed of the aircraft (1).

4. The method as claimed in claim 1, wherein at least one of a
distance (dᵣᵢₛₖ) between the hard boundary (4a) and the soft boundary (3a) or a distance (d_{cont}) between the soft boundary (3a) and the warning boundary (2a) at a location within the airspace is dynamically dependent on the current flight direction of the aircraft (1) relative to the warning, soft, and hard boundaries (2a-4a).

5. The method as claimed in claim 4, further comprising setting the warning and the soft boundaries (2a, 3a), which are in a flight direction (FR), at a greater distance from a current location of the aircraft (1) than the warning and the soft boundaries (2a, 3a), which are parallel to or counter to the flight direction (FR).

6. The method as claimed in claim 1, further comprising defining the warning, soft, and hard boundaries (2a-4a) by the steps of:
i) initially defining a course of the hard boundary (4a);
ii) calculating distances d_{cont} and dᵣᵢₛₖ in dependence on the flight status;
iii) then defining a course of the soft boundary (3a) and the warning boundary (2a) in that the course of the hard boundary (4a) is reproduced at a distance dᵣᵢₛₖ to define the soft boundary (3a) and the course of the soft boundary (3a) is reproduced at a distance d_{cont} to define the warning boundary (2a).

7. The method as claimed in claim 1, further comprising calculating a probability of infringement of at least one of the warning, soft, and hard boundaries (2a-4a) at a specific point by the aircraft (1) taking into consideration an angle difference (φ) between the relevant one of the warning, soft, and hard boundaries (2a-4a) and a current flight direction (FR) of the aircraft (1), wherein the probability decreases with increasing angle difference (φ) in relation to the current flight direction (FR), which probability is used for the dynamic calculation of a location of at least one of the warning boundary (2a) or the soft boundary (3a).

8. The method as claimed in claim 7, wherein to calculate the warning and soft boundaries (2a, 3a), a Euclidean distance (d) to a linear boundary section is described as a piecemeal continuous function of the angle difference (φ) between the current flight direction (FR) and a respective point on a boundary section, wherein resulting distance functions are scaled using a weighting function (ƒ_{weight}), said weighting function (ƒ_{weight}) depicts a probability of an abrupt direction change of the aircraft (1) as a function of the angle difference (φ), from which new distance values (d_{DW∘D}) result, which take into consideration both the Euclidean distance (d) and the probability that the warning or soft boundary (2a, 3a) will be infringed at the respective point.

9. The method as claimed in claim 8, further comprising defining the warning, soft, and hard boundaries (2a-4a) by the steps of:
i) initially defining a course of the hard boundary (4a);
ii) calculating distances d_{cont} and dᵣᵢₛₖ in dependence on the flight status;
iii) then defining a course of the soft boundary (3a) and the warning boundary (2a) in that the course of the hard boundary (4a) is reproduced at a distance dᵣᵢₛₖ to define the soft boundary (3a) and the course of the soft boundary (3a) is reproduced at a distance d_{cont} to define the warning boundary (2a); and
searching the new distance values (d_{DW∘D}) for a minimum and then comparing said minimum to the distances d_{cont} and dᵣᵢₛₖ.

10. The method as claimed in claim 8, wherein a Gaussian bell curve is used as the weighting function (ƒ_{weight}).

11. The method as claimed in claim 8, wherein the weighting function (ƒ_{weight}) is derived based on empirical data, said data depicting physical capabilities of the aircraft (1) for direction change in an extreme case.

12. The method as claimed in claim 8, further comprising weighting the distance (d_{DW∘D}) based on the flight direction (FR) to the warning, soft, and hard boundaries (2a-4a) as a foundation for a decision about an initiation of control measures for the aircraft (1).

13. A flight path control system of an aircraft (1), said flight path control system is configured to define boundaries (2a-4a) of an airspace authorized for a mission of the aircraft (1), said boundaries
a) comprise a hard boundary (4a) which delimits an area forbidden to the aircraft (1) and at least one of
b1) a warning boundary (2a), at which safety measures are initiated when the warning boundary is reached by the aircraft (1), or
b2) a soft boundary (3a), at which emergency measures are initiated when the soft boundary is reached by the aircraft (1),
the flight path control system comprising at least one of a computer-assisted flight path controller of the aircraft (1) or an external, computer-assisted flight path controller configured for calculating a location of at least one of the warning boundary (2a) or the soft boundary (3a), to continuously determine and dynamically take into consideration parameters of an actual flight status of the aircraft (1), including at least one of a current speed, a current altitude, a current path angle, or environmental factors, and
the at least one of the computer-assisted flight path controller of the aircraft (1) or the external, computer-assisted flight path controller is further configured to check whether the aircraft (1) presently or in future infringes at least one of the warning, soft, or hard boundaries (2a-4a) at a current position and to initiate corresponding control measures for the aircraft (1) if necessary.

14. The flight path control system as claimed in claim 13, wherein the at least one of the computer-assisted flight path controller of the aircraft (1) or the external, computer-assisted flight path controller is further configured to dynamically determine at least one of a distance (dᵣᵢₛₖ) between the hard boundary (4a) and the soft boundary (3a) or a distance (d_{cont}) between the soft boundary (3a) and the warning boundary (2a) at a location within the airspace depending on the current speed of the aircraft (1).

15. An aircraft (1), comprising the flight path control system as claimed in claim 13.
